(19) United States
(12) Patent Application Publication
(10) Pub. No.: US 2022/0413909 A1
(43) Pub. Date: Dec. 29, 2022

(54) TECHNIQUES TO ENABLE QUALITY OF SERVICE CONTROL FOR AN ACCELERATOR DEVICE

(71) Applicant: Intel Corporation, Santa Clara, CA (US)

(72) Inventors: Utkarsh Y. Kakaiya, Folsom, CA (US); Rajesh M. Sankaran, Portland, OR (US)

(21) Appl. No.: 17/359,409

(22) Filed: Jun. 25, 2021

(51) Int. Cl. G06F 9/48

(52) U.S. Cl. CPC G06F 9/4887

(57) ABSTRACT

Examples include techniques to enable quality of service (QoS) control for an accelerator device. Circuitry at an accelerator device implements QoS control responsive to receipt of a submission descriptor for a work request to execute a workload for an application hosted by a compute device coupled with the accelerator device. An example QoS control includes accepting the submission descriptor to a work queue at the accelerator device based on a work size of submission descriptor submissions of the application to the work queue over a unit of time not exceeding a submission rate threshold. The work queue is associated with an operational unit at the accelerator device to execute the workload based on information included in the submission descriptor. The work queue to be shared with at least one other application hosted by the compute device.

### TECHNICAL FIELD

Examples described herein are generally related to techniques to enable quality of service control for an accelerator device having shared work queues associated with workload or operation requests to the accelerator device.

### BACKGROUND

A Shared Work Queue (SWQ) is a type of work submission interface for an accelerator device that may be used by multiple independent software entities such as applications, containers, or applications/containers inside VMs to simultaneously place workload requests or work submissions to the accelerator device. In some examples, a work submission to an SWQ makes use of a type of request known as a Deferrable Memory Write request (DMWr). A DMWr may be used by software entities in accordance with the PCI Express (PCIe) Base Specification, Revision 4.0, Version 1.0 published in October 2017 (“PCIe specification”) and/or later revisions or versions of the PCIe specification. A software entity's use of DMWr may provide a mechanism for an accelerator device to carry out or defer an incoming DMWr. This mechanism may be used by an accelerator device to accept work from multiple non-cooperating software agents in a non-blocking way when the accelerator device is configured to support SWQs.

### BRIEF DESCRIPTION OF THE DRAWINGS

FIG. 1 illustrates an example first system.

FIG. 2 illustrates an example second system.

FIG. 3 illustrates an example first format.

FIG. 4 illustrates an example second format.

FIG. 5 illustrates example scoreboards.

FIG. 6 illustrates an example first logic flow.

FIG. 7 illustrates an example process.

FIG. 8 illustrates an example apparatus.

FIG. 9 illustrates an example second logic flow.

FIG. 10 illustrates an example of a storage medium.

FIG. 11 illustrates an example accelerator device.

### DETAILED DESCRIPTION

As contemplated by this disclosure, an accelerator device may be configured to operate as a type of scalable input/output (I/O) device to process work submissions using SWQs that are arranged to accept requests submitted via a DMWr formatted in accordance with the PCIe specification. In some examples, a software entity such as an application hosted by a central processing unit (CPU) of a compute device may submit a work request to an SWQ of the accelerator device responsive to one or more types of CPU instructions. The work request may be to offload a workload or operation. For example, the application may be hosted by an Intel® processor and the application may use an Enqueue Command (ENQCMD) instruction or an Enqueue Command as Supervisor (ENQCMDS) instruction to submit a work request to the SWQ of the accelerator device to offload the workload or operation. ENQCMD/S instructions, in some examples, carry an assigned Process Address Space Identifier (PASID) value in a work submission descriptor which allows the accelerator device to identify the software agent (e.g., an application) that is submitting the work request to offload a workload or operation. The offloaded workload or operation may be a type of data streaming operation such as, but not limited to, a move operation (e.g., memory move), a compress operation (e.g. data compress), a decompress operation (e.g. data decompress), an encrypt operation (e.g. data encrypt), a decrypt operation (e.g. data decryption), a fill operation (e.g., memory fill), a compare operation (e.g., memory compare), a flush operation (e.g., cache flush) or any combination thereof. ENQCMD/S instructions may cause a return of a Success or Retry (Deferred) indication by circuitry of the accelerator device to the software agent. Success indicates the work was accepted into the SWQ, while Retry indicates it was not accepted due to SWQ capacity constraints or other reasons. On a Retry status, the work submitter may back-off and retry later.

According to some examples, a high-level design of a scalable accelerator device capable of processing work submissions from multiple software entities may include circuitry to process work submissions. For example, the circuitry to process work submissions may include an acceptance unit, an execution unit and one or more work dispatchers. The acceptance unit may accept work submissions and causes descriptors associated with the accepted work submissions to be included in SWQs of the scalable accelerator device. The execution unit may facilitate execution of a workload or operation associated with the accepted work submissions by engine(s)/operational units of the scalable accelerator device. The work dispatcher(s) may dispatch the descriptors of the accepted work submissions from the SWQs to the execution unit for the execution unit to facilitate execution of the accepted work submissions.

In some examples, to support arbitration between a scalable accelerator device's SWQs, a defined group concept may be implemented. A defined group may be made-up of a set of SWQs and engines. Any engine/operational unit in a defined group may be used to process a descriptor posted/accepted to any SWQ in the defined group. Each SWQ and each engine may be associated with only one defined group. A work dispatcher of the scalable accelerator may follow a round-robin scheme to dispatch work accepted by an acceptance unit in an SWQ to an engine/operational unit. A weighted round-robin arbitration scheme may be supported by scalable accelerator devices to allow associating a priority with a SWQ.

According to some examples, the high-level scalable accelerator device design and use of group arbitration mentioned above allows for a SWQ-based work submission model that enables accelerator devices to scale with a relatively low amount of additional hardware costs. However, the above-mentioned type of SWQ-based work submission model presents a new set of challenges with respect to ensuring fairness among non-cooperating software entities. These challenges become greater when SWQs are exposed to tenants in a cloud type deployment via hardware assisted I/O virtualization. Hardware assisted I/O virtualization may result in a hostile/malicious tenant causing noisy neighbor challenges (e.g. submitting relatively large-sized work requests that result in temporary stalls for other tenants) or denial-of-service attacks (e.g. a tenant driver or multithreaded application continuously spinning in an infinite loop and queuing a continuous flow of work through ENQCMDS/ENQCMD instructions).

A current scheme to address noisy neighbor challenges or denial-of-service attacks for accelerator or I/O devices utilizing SWQ-based work submissions is implemented via a fixed partitioning of the hardware of the accelerator or I/O device. For example, an accelerator device may support 8 work queues (WQs) which can be configured in dedicated (DWQ) or shared (SWQ) mode. This accelerator device may also support 4 engines and have 4 defined groups. Given that this accelerator device only has 4 engines, scalability is limited to 4 tenants thereby defeating the whole purpose of SWQs and of being a scalable accelerator. A partial solution could include sharing an engine between WQs and assign an individual WQ to each tenant to enable fair-share, however scalability is still limited to only 8 tenants and there are end-to-end latency related challenges with this approach (e.g. one tenant submitting a 2 giga byte (GB) data-copy stalling the engine for longer periods of time and delaying a 4 kilo byte (KB) data-copy submitted by another tenant sharing the same engine). It is with respect to these challenges of balancing scalability of accelerator device while addressing such issues as noisy neighbor, denial-of-service attacks, or fairness among non-cooperating software entities that the examples described herein are needed.

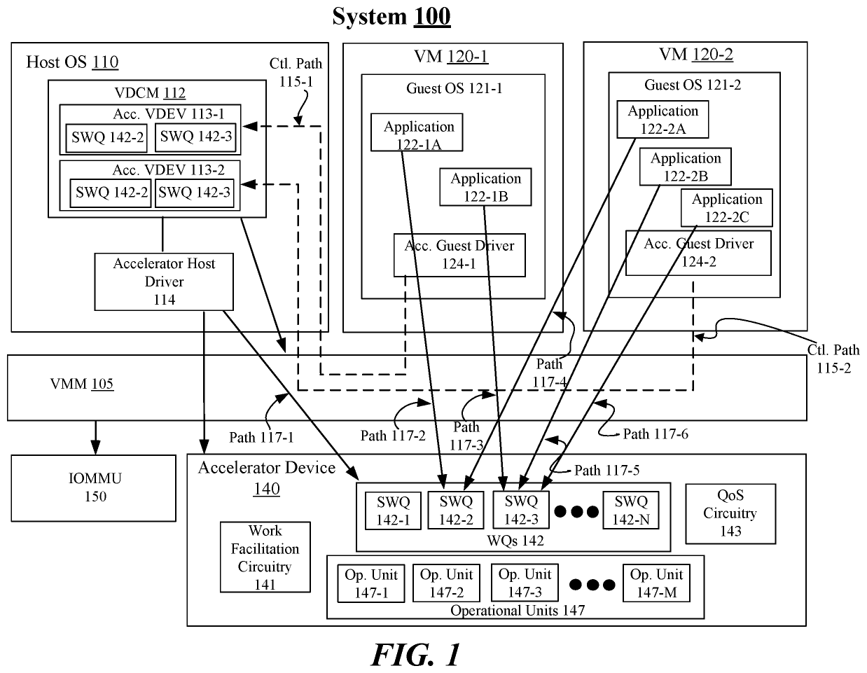

FIG. 1 illustrates an example system 100. In some examples, as shown in FIG. 1, system 100 includes a host operating system (OS) 110, a virtual machine (VM) 120-1, a VM 120-2, a virtual machine monitor (VMM) 105, an accelerator device 140 and an input-output memory management unit (IOMMU) 150. According to some examples, system 100 may be at least part of a host computing device supported by one or more host CPUs and/or multi-core processors (not shown). A host computing device may include, but is not limited to, a personal computer, a desktop computer, a laptop computer, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

According to some examples, system 100 may depict an example of a virtualized software architecture via which accelerator device 140 is virtualized via a type of scalable I/O virtualization (IOV), such as described in the Intel® Scalable I/O Virtualization Architecture Specification, published in June of 2018. In some other examples, accelerator device 140 is virtualized via single-root I/O virtualization (SR-IOV) or discrete device assignment (e.g. PCIe passthrough). For these examples, virtualization of accelerator device 140 may be supported by a software component of host OS 110 shown in FIG. 1 as a virtual device composition module (VDCM 112), which composes accelerator virtual devices (VDEVs) of accelerator device 140 and exposes the accelerator VDEV to guest OS 121-1 and guest OS 121-2 executed by respective VMs 120-1 and 120-2. In some alternative examples, VM 120-1 or VM 120-2 may be executing a virtualized or machine container. In some examples, VDCM 112 may be a type of module specific to VMM 105 and may be responsible for communicating with VMM 105 to facilitate virtualization of accelerator device 140. Depending on a host computing device's specific software architecture, VDCM 112 may be developed as a user level module, as part of the kernel mode driver, as a separate kernel module, or as part of VMM 105.

In some example, accelerator host driver 114 in host OS 110 may be extended to support VDCM 112 operations needed for virtualization of accelerator device 140. Similarly, accelerator guest drivers 124-1 and 124-2 of guest OS 121-1 and guest OS 121-2 for respective VMs 120-1 and 120-2 are also extended to facilitate access to accelerator device 140 by applications 122-1A/B and 122-2A-C. For these examples, accelerator host driver 114 controls and manages the physical accelerator device 140 and allows sharing of accelerator device 140 among accelerator guest drivers 124-1 and 124-2. In some examples, applications 122-A/B and 122-2A-C are user-mode applications, kernel-mode applications, user-mode drivers, kernel-mode drivers, containers, or any combination of thereof.

According to some examples, accelerator VDEVs 113-1 and 113-2 may be implemented by VDCM 112 as shown in FIG. 1. For these examples, accelerator VDEVs 113-1 and 113-2 may enable VDCM 112 to emulate a same interface as a physical interface to accelerator device 140 so that an accelerator driver can run in both host OS 110 and respective guest OS 121-1 and guest OS121-2. For example, accelerator guest drivers 124-1 and 124-2 may access respective accelerator VDEVs 113-1 and 113-2 through memory mapped I/O (MMIO) registers (not shown) using a same software interface as the physical accelerator device 140. VDCM 112 may emulate a behavior of accelerator device 140 and mediates guest subscription of accelerator device 140 through accelerator host driver 114. In some examples, as shown in FIG. 1, control paths 115-1 and 115-2 may be used for control path operations for respective accelerator VDEVs 113-1 and 113-2 from respective accelerator guest drivers 124-1 and 124-2 of VMs 120-1 and 120-2. Also, as described in more detail below, fast path operations may be implemented via paths 117-1 to 117-6 to submit work requests (descriptor submissions) to accelerator device 140 for execution by engines/operational units 147 through work queues (WQs) 142 and receive work completion indications (e.g., descriptor completions or interrupt notifications) associated with submitted work requests.

In some examples, as shown in FIG. 1, WQs 142 of accelerator device 140 includes shared work queues (SWQs) 142-1 to 142-N. SWQs 142-1 to 142-N may be included on device storage maintained at accelerator device 140 or may be hosted on system memory to temporarily store descriptor submissions. For these examples, “N” may represent any whole, positive number >3. Also, as shown in FIG. 1, different applications of guest OS 121-1 and guest OS 121-2 may be assigned to a same SWQ. For example, application 122-1A of guest OS 121-1 and application 122-2A of guest OS 121-2 may be assigned to SWQ 142-2 and application 122-1B of guest OS 121-1 and application 122-2B/C of guest OS 121-2 may be assigned to SWQ 142-3. Although not shown in FIG. 1, multiple applications hosted by other guest OSs executed by other VMs may be assigned to SWQs 142-1, 142-3 or 142-N. These other assignments to multiple applications of other guest OSs executed by other VMs are not shown in FIG. 1 for simplification purposes. In some examples, an SWQ from among SWQs 142-1 or 142-N may be assigned to a single guest OS and may also be shared by multiple applications of the single guest OS.

According to some examples, each SWQ included in an accelerator VDEV of VDCM 112 may directly map SWQ physical ports to applications of a guest OS executed by a VM. For example, physical ports of SWQs 142-2 and 142-3 may be directly mapped to VM 120-1 and 120-2 via respective accelerator VDEVs 113-1 and 113-2. This allows applications 122-1A and 122-2A to each send work requests to directly mapped physical port(s) for SWQ 142-2 and allows applications 122-1B and 122-2B/C to each send work requests to directly mapped physical port(s) for SWQ 142-3.

In some examples, applications 122-1A/B and 122-2A-C having mapped access to SWQ included in WQs 142 are configured to use separately assigned process address space identifiers (PASIDs). For these examples, VMM 105 may allocate a default host PASID for a given VM and then configure a PASID table entry for that default host PASID in IOMMU 150 for a second level address translation (e.g., guest physical address to host physical address).

In examples where shared virtual memory is supported by guest OS 121-1 and 121-2, accelerator VDEVs 113-1 and 113-2 include support for PASID. For these examples, VMM 105 may expose a virtual IOMMU of IOMMU 150 to these guest OSs. Guest OS 121-1 and guest OS121-2 may set up PASID table entries in this virtual IOMMU's PASID table. In some examples, VMM 105 may choose to use a para-virtualized or enlightened virtual IOMMU where guest OS 121-1 and guest OS 121-2 do not generate their own guest PASIDs but instead request guest PASIDs from the virtual IOMMU of IOMMU 150. These guest PASIDs may then be assigned to each application executed or supported by guest OS 121-1 and guest OS 121-2 to uniquely identify each application via their respectively assigned PASIDs.

According to some examples, as described more below, an application (e.g., application 121-1A) may use an ENQCMD/S instruction that carries an assigned PASID to submit a work request to accelerator device 140. For these examples, the work request may include a submission descriptor that allows accelerator device 140 to identify the application and return a submission Success or Retry indication to the application responsive to the work request. Also, as described more below, logic and/or features of work facilitation circuitry 141 may facilitate accepting and executing the work submission using SWQs 142-1 to 142-N and operational units 147 and logic and/or features of quality of service (QoS) circuitry 143 may facilitate QoS operations to ensure, for example, that one or more service level objectives (SLOs) of the application as well as other applications sharing a same SWQ are met as accelerator device 140 fulfills the work request.

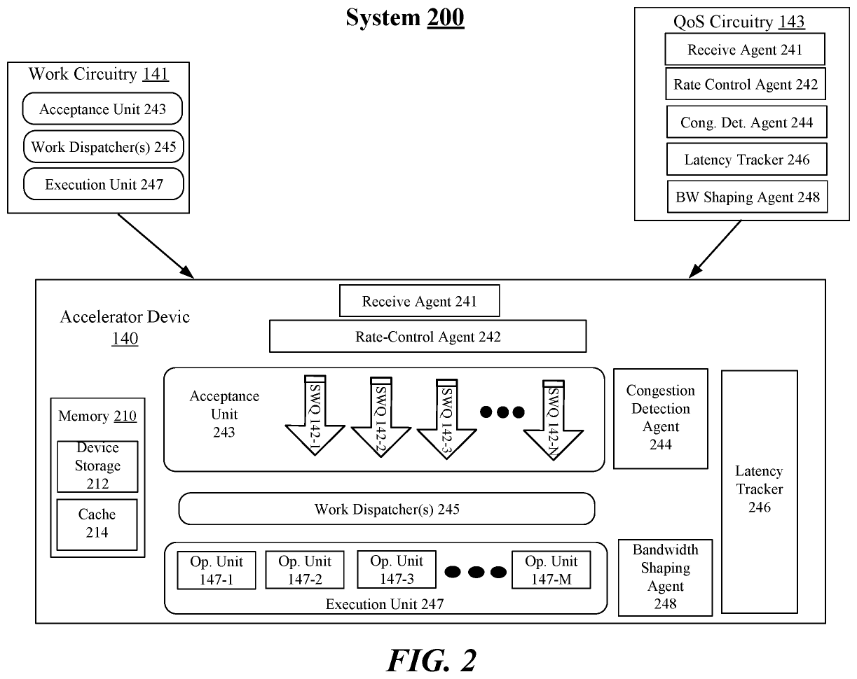

FIG. 2 illustrates an example system 200. In some examples, as shown in FIG. 2, system 200 includes accelerator device 140 as mentioned above for FIG. 1. Also, as shown in FIG. 1, accelerator 140 is shown in FIG. 2 as including work facilitation circuitry 141, QoS circuitry 143, SWQs 142-1 to 142-N and operational units 147-1 to 147-M, where “M” is a whole positive number. For these examples, as shown in FIG. 2, work facilitation circuitry 141 is shown as including an acceptance unit 243, work dispatcher(s) 245 and an execution unit 247. Also, as shown in FIG. 2, QoS circuitry 143 includes a receive agent 241, a rate control agent 242, a congestion detection agent 244, a latency tracker 246 and a bandwidth shaping agent 248. According to some examples, work facilitation circuitry 141 and QoS circuitry 143 may be executed by a same or separately executed by a different processor circuit, processor, application specific integrated circuit (ASIC) or field programmable gate array (FPGA) resident on accelerator device 140. Also, operational units 147-1 to 147-M may be part of a same processor circuit, processor, ASIC or FPGA as used to execute work facilitation circuitry 141 and/or QoS circuitry 143.

In some examples, as shown in FIG. 2, acceptance unit 243, work dispatcher(s) 245 and execution unit 247 are depicted as being dispersed within accelerator device 240. For these examples, this dispersion illustrates how elements of work facilitation circuitry 141 may process work submissions received from software entities such as applications 122-1A/B and 122-2A-C. Acceptance unit 243 may accept work submissions and cause submission descriptors associated with the accepted work submissions to be included in SWQs 142-1 to 142-N of accelerator device 140. Execution unit 247, in some examples, may facilitate execution of a workload or operation associated with the accepted work submissions by engines/operational units 147-1 to 147-M. Work dispatcher(s) may dispatch the descriptors of accepted work submissions from SWQs 142-1 to 142-N to execution unit 247 for execution unit 247 to facilitate execution of the accepted work submissions. According to some examples, operational units 147-1 to 147-M may be part of a same processor circuit, processor, ASIC or FPGA used to execute functional elements of work facilitation circuitry 141 or QoS circuitry 143. In other examples, operational units 147-1 to 147-M may part of a different processor circuit, processor, ASIC or FPGA resident on accelerator device 140.

According to examples, as shown in FIG. 2, receive agent 241, rate control agent 242, congestion detection agent 244, latency tracker 246 and bandwidth shaping agent 248 are also depicted as being dispersed within accelerator device 240. For these examples, this dispersion illustrates how elements of QoS circuitry 143 may facilitate QoS operations to ensure, for example, that one or more SLOs for software entities such as applications 122-1A/B and 122-2A-C are met as accelerator device 140 fulfills accepted work submissions.

In some examples, receive agent 241 may be capable of receiving submission information associated with work requests to execute a workload for software entities such as applications 122-1 A/B and 122-2A-C. As described more below, the submission information may be included in a data structure that may be referred to as a submission descriptor (also described more below).

In some examples, rate control agent 242 may be capable of throttling inbound or received work submission requests to possibly be accepted by work acceptance unit 243 to one or more SWQs 142-1 to 142-N. As described in more detail below, rate control agent 242 may maintain a scoreboard (e.g., in memory 210) that tracks a submission rate per PASID and throttles the submitting entity if the submission rate of a particular PASID exceeds a submission threshold rate. The submission rate, for example, may be based on a work size of submission descriptor submissions, the work size may indicate either a number of submission descriptors submitted over a unit of time and/or may indicate a data size (e.g., amount of data read, written or processed for a given work request) indicated in submission descriptors submitted over the unit of time. In some examples, the submission threshold rate may be pre-configured by system software (e.g., host OS 110) that sets the submission threshold such that it is based on a limit to a number of submission descriptors submitted over the unit of time and/or based on a data size accepted or processed over the unit of time. Rate control agent 242 may track one or more submission rates based on one or more and/or of a combination of granularities to include, but not limited to, a device granularity (e.g., submission descriptors submitted to two different SWQs with same PASID will share same scoreboard entry), an SWQ granularity, a class-of-service (COS) granularity or a session granularity. Each of these scoreboard tracking granularities may allow system software to pre-configure/control QoS at various granularity levels to enable rate control agent 242 to implement different rate control schemes. Rate control agent 242's implementation of the different scoreboard tracking granularities may facilitate the meeting of one or more SLOs. Rate control agent 242 may also be capable of providing privileged software entities an ability to examine/dump scoreboard information (e.g. for analysis or load-balance purposes).

According to some examples, SWQs 142-1 to 142-N are shared between non-cooperating software entities (e.g., applications executed by a same or different guest OS). For these examples, rate control agent 242 may ensure that one particular work request submitter to accelerator device 140 doesn't flood accelerator device 140 with requests and other work request submitter(s) get a fair chance at queuing their respective work requests to SWQs 141-1 to 142-N. For example, an SWQ may have N slots to queue submission descriptors. Rate control agent 242 may be capable of allowing any particular request submitter to occupy a limit of M slots with their submission descriptors for work submission requests at any one point of time.

In some examples, scoreboard tracking information gathered or obtained by rate control agent 242 may be maintained in device storage 212 included in memory 210 for accelerator device 140. Device storage 212 may include volatile and/or non-volatile types of memory resident on accelerator device 140 and may also be arranged to provide storage to support SWQs 142-1 to 142-N. In other examples, the scoreboard tracking information may be maintained in system memory for the host computing device that includes system 100. For these other examples, cache 214 may be arranged to serve as an on-device cache to the system memory. Cache 214 may also include volatile and/or non-volatile types of memory. Rate control agent 242 may use a different communication channel than what is used to respond to work submission requests via ENQCMD/S instructions to prevent circular dependency due to pending ENQCMD/S responses on a channel used to convey the work submission requests to accelerator device 140 (e.g., an I/O fabric) and to meet ordering requirements for the channel used to convey the work submission requests.

According to some examples, rate control agent 242 may examine a data size of a submission descriptor submission (e.g. data transfer size for data-copy operations or input data size for data-compression operations) to calculate a submission rate for a PASID associated with the work submission request. Rate control agent 242 may also examine the data size instead of just relying on a submission descriptor count for a given PASID. In some examples, examination of data size may cause rate control agent 242 to further extend scoreboard entries to store an I/O rate or IO per second (IOPS), and throttle work submitter requests from that requester when the I/O rate for that PASID exceeds a pre-configured threshold I/O rate.

In some examples, rate control agent 242 may also evaluate an engine/operational unit time-quantum spent by previously submitted descriptors belonging to a same offload session for workloads or operations executed by one or more operational units 147-1 to 147-M of accelerator device 140. For these examples, evaluation of a time-quantum may cause rate control agent 242 to further extend scoreboard entries to include additional information such as time-quantum or execution-time so that new work submission requests are accepted or rejected not just based upon the I/O and/or submission rate but also based upon the execution-time spent by previously submitted work requests belonging to the same offload session (e.g. from a same PASID). Such techniques may be useful for scalable accelerators where the time-quanta spent can vary significantly based on how input data is to be processed by operational units 147-1 to 147-M (e.g. decompression or encoding of input data). A time-quanta evaluation may also be useful to prevent against compute-virus based attacks.

According to some examples, a submission descriptor is accepted into an SWQ by acceptance unit 243, the submission descriptor may sit in the SWQ for a period of time before it is dispatched by work dispatcher(s) 245 to an operational unit from among operational units 147-1 to 147-M to fulfill the work request associated with the submission descriptor. In some typical usage models for accelerator devices, a software entity may have a choice on whether to execute a workload or operation on a host CPU or offload the workload or operation to an accelerator. Scheduling delays at an accelerator device caused by busy/congested operational units may result in missing deadlines for latency sensitive operations and can also impact responsiveness/user-experience in a negative manner or increase tail-latencies. For these examples, it is important for the software entity to be able to deterministically figure-out whether to offload the workload or operation to an accelerator (based on the latency information) or just utilize the CPU to execute the workload or operation to meet one or more SLOs.

In some examples, congestion detection agent 244 may be responsible for detecting congestion at SWQs 142-1 to 142-N and/or operational units 147-1 to 147-M and ensuring that submitting entities are not being penalized due to long waiting delays caused by heavily bottlenecked/congested SWQs or operational units. For these examples, congestion detection agent 244 may achieve this by early completing/failing submission descriptors for work requests to allow software entities to continue handling workloads, rather than waiting longer for engines/operational units to free-up.

According to some examples, congestion detection agent 244 may maintain the arrival-time for each submission descriptor accepted/hosted into SWQs 142-1 to 142-N (potentially stored alongside the submission descriptor in each SWQ slot). For these examples, congestion detection agent 244 may provide system software (e.g., host OS 110) an ability to enable/disable congestion detection agent 244's monitoring per-SWQ and also provide system software an ability to pre-configure or set latency thresholds or expectations. Congestion detection agent 244 may also provide an option for a work requester to decide whether they would like to enroll into early completions due to deadline expiration by providing an enroll flag as part of the submission descriptor.

In some examples, if congestion detection agent 244's monitoring per-SWQ is enabled, congestion detection agent 244 continuously monitors the wait-time (i.e. current_time-arrival_time) for submission descriptors accepted into SWQs 142-1 to 142-N. In the event that a particular submission descriptor has reached its expiration-time and the work requester has requested a deadline expiration, congestion detection agent 244 may pull the submission descriptor out of a SWQ from among SWQs 142-1 to 142-N and pre-maturely cause the work request submission to be completed (Success)/failed (Retry)—enabling the work requester to fallback to other means of executing the offloaded workload or operation (past the deadline) rather than waiting for a possible congested accelerator device 140 to free-up.

According to some examples, latency tracker 246 may be responsible for tracking a time spent by a submission descriptor accepted to SWQs 142-1 to 142-N waiting for an operational unit from among operational units 147-1 to 147-M availability, memory access time to access (e.g., read, write) data for executing the work request and execution time on the operational unit. Latency tracker 248 may provide this latency tracking information to the work requester to enable the work requester to make subsequent offload decisions to accelerator device 140. In some examples, latency tracker 246 may use precision time control to allow work requesters/software entities to use existing techniques such as Read Time-Stamp Counter (RDTSC) instructions for time synchronization.

In some examples, latency tracker 246 may provide an ability to a privileged software entity to enable/disable latency tracking functionality at a device, a SWQ or COS granularity. For these examples, submitting software entity or work requestor may selectively assert a flag in a submission descriptor associated with a work request to indicate whether latency timing information is requested. In the event that latency tracking functionality is enabled, and the latency timing information is indicated as enabled in the submission descriptor, latency tracker 246 may capture timestamp data (e.g. submission descriptor arrival time, memory access start time or execution start time) for execution of a work request associated with the submission descriptor as the work request flows through an execution pipeline at accelerator device 140. Latency tracker 246 may finally populate timestamp information as part of a work completion record associated with completion of the work request. The timestamp information may allow the submitting software entity or work requester to make intelligent offload decisions. For example, stop offloading to a given SWQ from among SWQs 142-1 to 142-N or to accelerator device 140 in instances of observed long delays, or load balance across multiple accelerator devices or just revert to use of the host CPU to perform workloads or operations on occasions where latency tracking information indicates that accelerator device 140 may be unacceptably congested.

According to some examples, each operational unit from among operational units 147-1 to 147-M may be competing for memory bandwidth to execute requested workloads or operations. Also, in situation where a set of work requesters are submitting work requests at a relatively higher rate than another set of work requesters, there would be challenges with respect to not getting a fair-share on the memory pipe to execute requested workloads or operations. For these examples, bandwidth shaping agent 248 may determine memory bandwidth consumed by each operational unit from among operational units 147-1 to 147-M and perform bandwidth shaping by throttling operational units which are going beyond their respective allocated share of memory bandwidth. In some examples, system software (e.g., host OS 110) may set allocations of memory bandwidth via a configuration of minimum, maximum and a shared memory bandwidth quota for each operational unit from among operational units 147-1 to 147-M. Bandwidth shaping agent 248 may then enforce minimum, maximum and a shared memory bandwidth quota to shape respective memory bandwidth for each of the operational units of accelerator device 140.

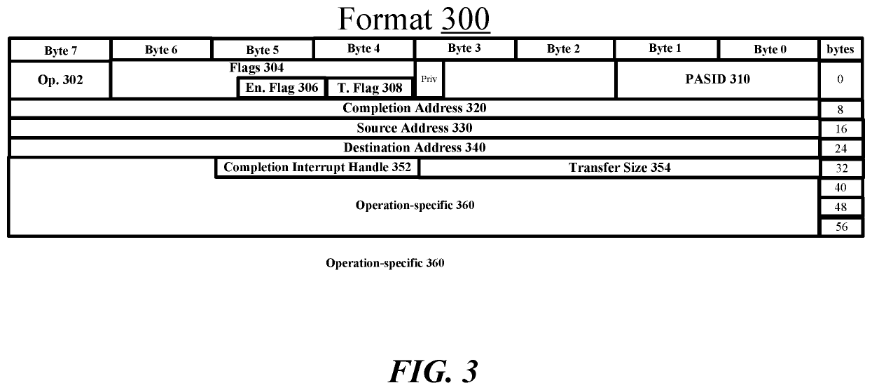

FIG. 3 illustrates an example format 300. Example format 300 may be an example format of a submission descriptor that, as shown in FIG. 3, includes up to 64 bytes of information in various fields. In some examples, format 300 may be used for a submission descriptor associated with work request submitted to accelerator device 140 shown in FIGS. 1 and 2 and mentioned above. For these examples, operation (Op.) 302 field may include information to indicate a type of workload or operation associated with the work request submitted to accelerator device 140 (e.g., No-op, batch, drain, memory move, fill, compare, compare pattern, create delta record, memory copy, data compression, data decompression, data encryption, data decryption, cyclic redundancy check (CRC) generation, copy with CRC generation, data integrity field (DIF) check, DIF insert, DIF strip, DIF update or cache flush). Flags 304 field may include information indicating a setting of flags associated with executing the work request. In some examples, as shown in FIG. 3, flags 304 field includes an Enroll (En.) flag field 306 that may include information to indicate whether the work requester is enrolling in congestion detection (e.g., implemented by congestion detection agent 244) to provide the work requester an option to have early completions/retry indications due to a need to meet a deadline requirement. In addition to indicating enrollment, En. Flag field 306 may also indicate an expiration time that if met, exceeded, or reached, the descriptor submission for the work request is to be pulled or removed from a SWQ to cause the work request to be canceled. Also as shown in FIG. 3, flags 304 field may also include a timing (T.) flag field 308 that may include information to indicate whether the work requester wants to gather latency tracking information associated with the work request. PASID 310 field includes the PASID assigned to the work requestor. Completion address 320 field specifies an address of a completion record (described more below) associated with the work request. Source address 330 field indicates a source address to read data from a memory (e.g., system memory). Destination address 340 field may include information to indicate an address to write data associated with completing the work request. Completion interrupt handle 352 may include information to specify an interrupt table entry to be used to generate a completion interrupt (e.g., to a host CPU). Transfer size 354 field may indicate a number of bytes to be read from the source address indicated in source address 330 to execute the work request. Operation-specific 360 may include information specific to the work request associated with the submission descriptor.

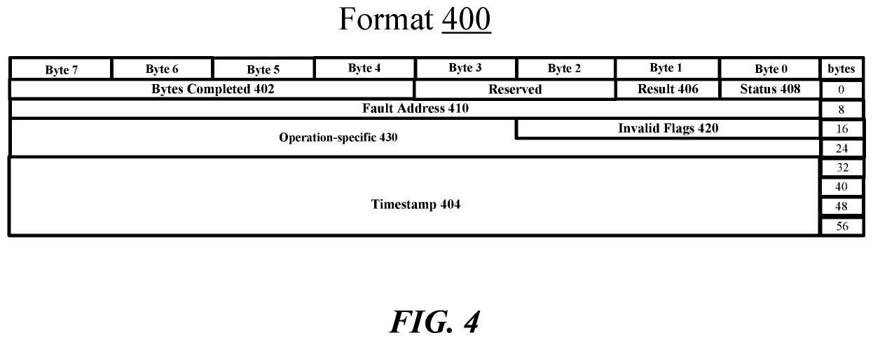

FIG. 4 illustrates an example format 400. Example format 400 may be an example format of a completion record that, as shown in FIG. 4, includes up to 64 bytes of information in various fields. In some examples, format 400 may be an example of a data structure used by an accelerator device (e.g., accelerator device 140) to write information following a Success or error condition associated with a work request to the accelerator device made via a descriptor submission submitted using example format 300 shown in FIG. 3. For these examples, byte completed 402 field may include information to indicate that if an operation associated with the work request was partially completed, the number of source bytes processed before a fault or error condition occurred. Time stamp 404 field may include information associated with latency tracking (e.g., populated by latency tracker 246) as a work request flows through an execution pipeline at the accelerator device. Result 406 field may include information about a result of the operation associated with the work request. Status 408 field may include information to indicate a status of a submission descriptor associated with the work request (e.g., Success or Retry). Fault address 410 field may include information, if a fault occurs, to indicate a memory address that caused the fault. Invalid flags 420 field may include information to indicate which flags included in flags 304 field of the submission descriptor are found to be invalid. Operation-specific 430 field may include information specific to the work request associated with the submission descriptor submitted by the work requester.

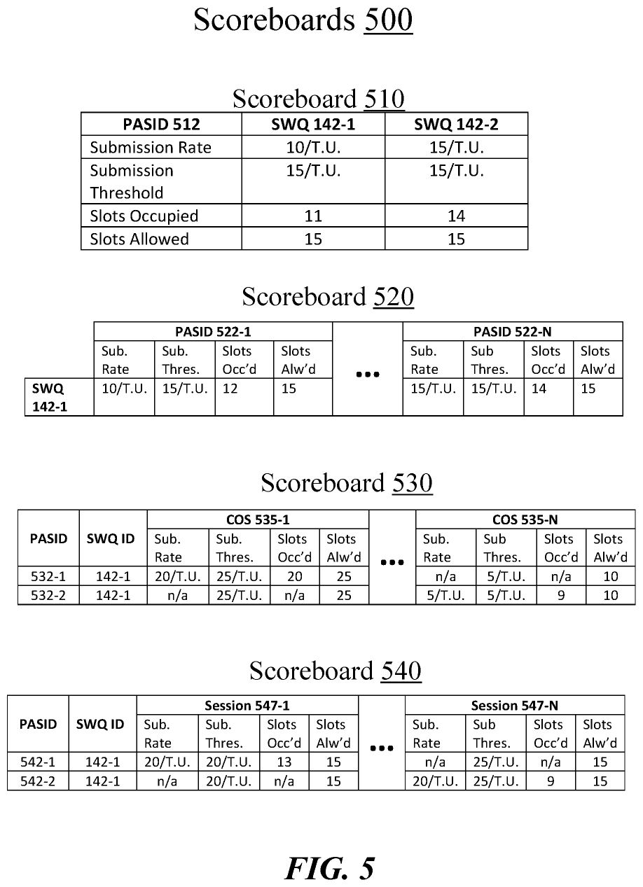

FIG. 5 illustrates example scoreboards 500. According to some examples, scoreboards 500 may represent examples of scoreboards of various granularities used by rate control agent 242 of QoS circuitry 143 of accelerator device 140 to track work submission descriptions submitted to SWQs from among SWQs 142-1 to 142-N for execution by one or more operational units among operational units 147-1 to 147-M. For these examples, a simplified version of entries tracked by rate control agent 242 are shown in FIG. 5 for scoreboards 510, 520, 530 and 540 that include a submission rate, a submission threshold, slots occupied, and slots allowed. Examples are not limited to scoreboards that include only the entries shown in FIG. 5. As mentioned above, rate control agent 242 may also track additional information such as, but not limited to, an I/O rate and/or time-quanta information.

According to some examples, as shown in FIG. 5, scoreboard 510 illustrates a type of device granularity scoreboard entry that tracks a single PASID of a work requester that is submitting work requests to two different SWQs. For these examples, PASID is submitting work requests to SWQs 142-1 and 142-2. System software may have set a submission threshold of 15 submission descriptors from a given PASID per time unit (T.U.) for both SWQ 142-1 and 142-2. The system software has also placed a limit on a number of queue slots allowed to be occupied for SWQ 142-1 and 142-2 to no more than 15 queue slots. Scoreboard 510 indicates that PASID 512 has hit the submission threshold of 15/T.U. for SWQ 142-2. As a result of hitting the submission threshold, rate control agent 242 may throttle back or block subsequent submission descriptors to SWQ 142-2 from PASID 512 even though PASID 512 has not yet reached the slots allowed threshold.

In some examples, as shown in FIG. 5, scoreboard 520 illustrates a type of SWQ granularity scoreboard that tracks submission descriptors from multiple PASIDs individually associated with multiple work requesters to a single SWQ 142-1. For these examples, the same thresholds may be set for submission descriptors as mentioned above for scoreboard 510. Scoreboard 510 indicates that PASID 522-N has reached the descriptor submission threshold and subsequent work requests from PASID 522-N will need to be throttled by rate control agent 242.

According to some examples, as shown in FIG. 5, scoreboard 530 illustrates a type of class of service (COS) granularity scoreboard that tracks submission descriptors from multiple PASIDs individually associated with multiple work requesters to a single SWQ 142-1, the multiple PASIDs having different COS requirements (e.g., needed to meet one or more SLOs). For example, PASID 532-1 may have COS 535-1 requirements that sets a descriptor submission threshold of 25/T.U. and allows for 25 queue slots on SWQ 142-1. Meanwhile PASID 532-2 may have COS 535-N requirements that sets a much lower descriptor submission threshold of 5/T.U. and allows for 10 queue slots. The relatively higher descriptor submission threshold and allowed queue slots for PASID 532-1 indicates a higher COS for this particular work requester compared to PASID 532-2. In some examples, COS may be based, at least in part, on PCIe Traffic Classes as defined in the PCIe specification.

In some examples, as shown in FIG. 5, scoreboard 540 illustrates a type of session granularity scoreboard that tracks submission descriptors from multiple PASIDs individually associated with multiple work requesters to a single SWQ 142-1, the multiple PASIDs having different offload sessions to accelerator device 140. For these examples, the different offload sessions may have different descriptor submission and allowed queue slot thresholds. For example, PASID 542-1 may have an offload session 547-1 that has requirements that sets a descriptor submission threshold of 20/T.U. and allows for 15 queue slots on SWQ 142-1. Meanwhile PASID 542-2 may have an offload session 547-N that has requirements that sets a higher descriptor submission threshold of 25/T.U. and allows for 15 queue slots. The higher descriptor submission threshold for PASID 542-1 may indicate a slightly higher priority to session 547-N compared to session 547-1.

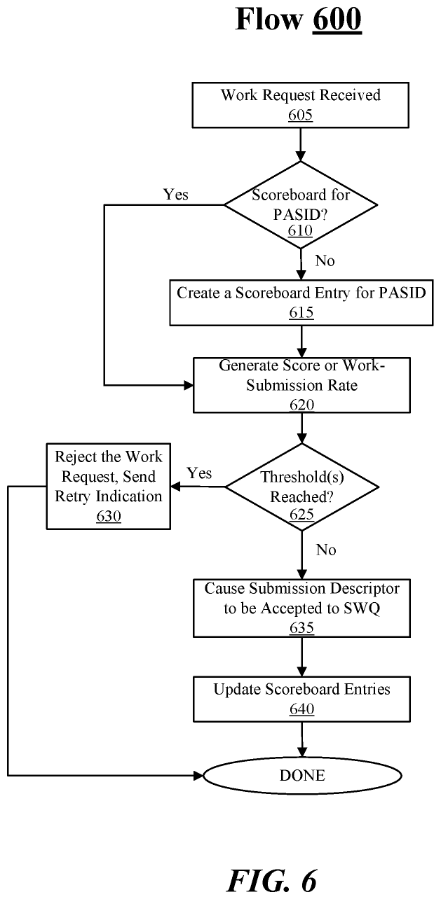

FIG. 6 illustrates an example logic flow 600. In some examples, logic flow 600 may be implemented by logic and/or features of circuitry at an accelerator device such as logic and/or features of QoS circuitry 143 of accelerator device 140 shown in FIGS. 1 and 2. The logic and/or features of QoS circuitry 143 may include, but are not limited to, receive agent 241 and rate control agent 242 as shown in FIG. 2. For these examples, software entities (e.g., applications 122-1A/B, 122-2A-C) having assigned PASIDs may submit work requests to offload at least a portion of a workload or operation to accelerator device 140 for execution by one or more operational units 147-1 to 147-M.

Logic flow 600 begins at block 605 where a work request is received by accelerator device 140. According to some examples, an application having an assigned PASID may generate an ENQCMD/S instruction that carries the assigned PASID in a submission descriptor. The submission descriptor, for example, may be in the format of example format 300 shown in FIG. 3. In some examples, the submission descriptor may also be referred to as a Deferrable Memory Write Request (DMWr) as described by the PCIe specification. For these examples, receive agent 241 may obtain or receive the information included in the submission descriptor for other logic and/or features of circuitry 143 to use (e.g., rate control agent 242) to facilitate QoS operations.

Moving from block 605 to decision block 610, responsive to receipt of the work request, rate control agent 242 may determine whether a scoreboard can be found (e.g., in device storage 212 or in system memory via cache 214) that has entries for the PASID included in the submission descriptor. If a scoreboard having entries for the PASID is not found or does not exist, logic flow 600 moves to block 615. If a scoreboard having entries for the PASID is found, logic flow 600 moves to block 620.

Moving from decision block 610 to block 615, rate control agent 242 may create a new scoreboard for the PASID or add entries for an existing scoreboard. In some examples, the scoreboard may be based on an SWQ granularity and may be similar to scoreboard 520 shown in FIG. 5. For these examples, rate control agent 242 may generate entries for the PASID in scoreboard 520 to utilize SWQ 142-1 for submitting the work request.

Moving from either decision block 610 or from block 615 to block 620, rate control agent 242 may generate score or work-submission rate based on the scoreboard entries for the PASID. In one example, a scoreboard was found by rate control agent 242 having similar entries as shown for scoreboard 520.

Moving from block 620 to decision block 625, rate control agent 242 may determine whether any thresholds have been reached. In the example where similar entries as shown for scoreboard 520 are found and if the PASID corresponded to PASID 522-N, then rate control agent 242 determines that the submission rate threshold of 15/T.U. has been reached and logic flow 600 moves to block 630. Alternatively, if the PASID corresponded to PASID 522-1, then rate control agent 242 determines that the submission rate threshold of 15 T.U. has not been reached and logic flow 600 moves to block 635.

Moving from decision block 625 to block 630, rate control agent 242 rejects the work request and causes a Retry indication to be generated so that the work requester is aware that work submissions are being throttled for requests from that particular work requester. The work requester may either wait and resubmit the work request or seek other options for execution of the work request.

Moving from decision block 625 to block 635, rate control agent 242 causes the submission descriptor to be accepted to an SWQ (e.g., SWQ 142-1) at accelerator device 140. In some examples, the acceptance of the submission descriptor may cause at least one queue slot of the SWQ to be occupied.

Moving from block 635 to block 640, rate control agent 242 updates the scoreboard having entries for the PASID for which the submission descriptor was accepted to the SWQ at accelerator device 140. The updated entries, for example, may indicate that an additional queue slot of SWQ 142-1 has been occupied. For example, scoreboard 520's entries for PASID 522-1 are updated to indicate 13 queue slots for SWQ 142-1 are occupied by this particular PASID.

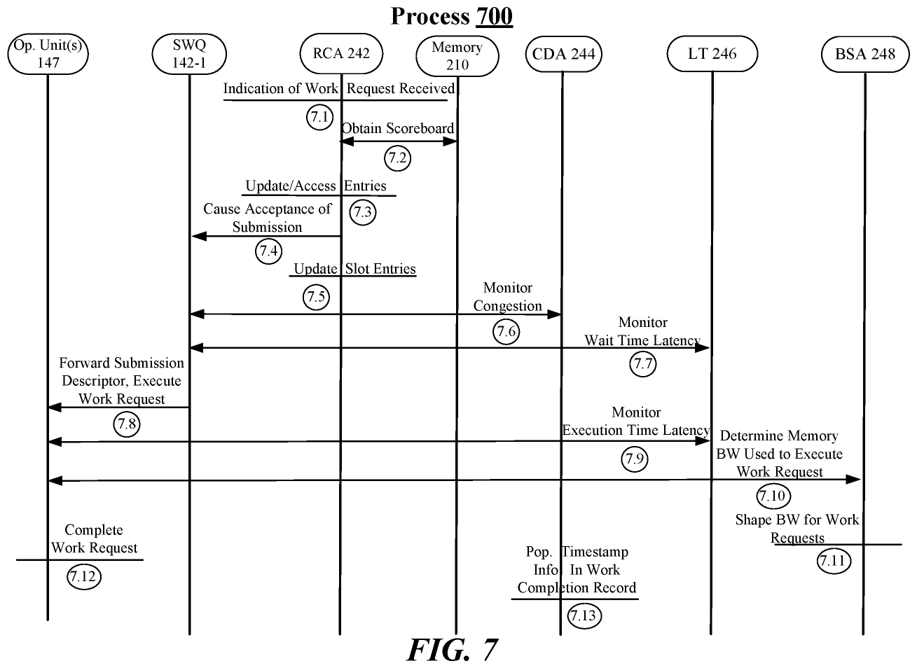

FIG. 7 illustrates an example process 700. In some examples, process 700 may be illustrate how elements of an accelerator device such as QoS circuitry 143 of accelerator device 140 facilitate QoS operations to ensure, for example, that one or more SLOs for software entities such as applications 112-1A/B and 122-2A-C having assigned PASIDs are met as operational unit(s) 147 of accelerator device 140 fulfills accepted work submission. For these examples, submission descriptors in example format 300 shown in FIG. 3, may be used to submit work request and work completion records in example format 400 shown in FIG. 4 may be used to indicate a status of the submitted work request. Scoreboard entries such as entries for scoreboard 520 shown in FIG. 5 may also be used to determine whether to accept work submissions. Examples are not limited to elements of accelerator device 140 as shown in FIGS. 1 and 2 or to the example formats or scoreboards shown in FIG. 3, 4 or 5.

Beginning at 7.1, rate control agent 242 receives an indication from receive agent 241 that a work request has been received. According to some examples, an application having an assigned PASID may generate an ENQCMD/S instruction that carries the assigned PASID in a submission descriptor. The submission descriptor, for example, may be in the format of example format 300 shown in FIG. 3. In some examples, the submission descriptor may also be referred to as a DMWr as described by the PCIe specification.

Moving to 7.2, rate control agent 242 obtains a scoreboard that has entries for the PASID included in the submission descriptor/DMWr. In some examples, the scoreboard may be similar to scoreboard 520 and may have been stored in memory 210 (e.g., in device storage 212). For these examples the PASID may correspond to PASID 522-1

Moving to 7.3, rate control agent 242 may update the scoreboard entries for the PASID. In one example, scoreboard 520 entries for PASID 522-1 may be updated by rate control agent 242 to indicate the newly submitted work request.

Moving to 7.4, rate control agent 242 causes the submission descriptor to be accepted to SWQ 142-1. In some examples, the acceptance of the submission descriptor may cause at least one queue slot of SWQ 142-1 to be occupied.

Moving to 7.5, rate control agent 242 updates the entries for PASID 522-1 scoreboard to indicate that an additional queue slot of SWQ 142-1 has been occupied by a submission descriptor associated with PASID 522-1.

Moving to 7.6, congestion detection agent 244 may monitor for congestion at SWQ 142-1. According to some examples, the En. Flag 306 field of the submission descriptor may indicate that PASID 522-1 has requested to enroll in possible early completions and also indicate an expiration time via which PASID 522-1 may have to pull the work request if a wait time for SWQ 142-1 to forward the work request to operational unit(s) 147 to execute or fulfill the work request reaches, meets or exceeds the expiration time.

Moving to 7.7, latency tracker 246 may track a latency time between when the submission descriptor for PASID 522-1's work request is accepted to SWQ 142-1 and when work execution begins at operational unit(s) 147 (e.g., wait time latency). In some examples, information included in T. flag 308 field of the submission descriptor may indicate that PASID 522-1 has requested timing information related to latencies associated with processing PASID 522-1's work request from acceptance to SWQ 142-1 through completion of the work request.

Moving to 7.8, execution of the work request associated with PASID 522-1 submission descriptor is passed through or forwarded from SWQ 142-1 and operational unit(s) 147 begins executing the work request.

Moving to 7.9, latency tracker 246 tracks latency times associated with execution of the work request by operational unit(s) 147 as the work request moves through an execution pipeline (e.g., execution latency).

Moving to 7.10, bandwidth shaping agent 248 may determine memory bandwidth consumed by one or more operational units among operational unit(s) 147 in order to execute the workload or operation associated with the work request.

Moving to 7.11, bandwidth shaping agent 248 may shape or adjust memory bandwidth for the one or more operational units of operational unit(s) 147 for subsequent execution of work requests based on the determined memory bandwidth consumed. According to some examples, bandwidth shaping agent 248 may cause a throttling or reduction in memory bandwidth available to the one or more operational units if a share memory bandwidth quota for memory bandwidth shared with other operational units at accelerator device 140 is exceeded.

Moving to 7.12, operational unit(s) 147 have completed the work request and cause a work completion record in the example format 400 to be generated and stored to a memory address indicated in completion address 320 field of the submission descriptor. In some examples, scoreboard entries may be updated to tally/capture statistics associated with completion of the work request.

Moving to 7.13, latency tracker 246 may populate timestamp 404 field of the work completion record to include timestamp information associated with various latencies tracked by latency tracker 246 to include, but not limited to, submission descriptor arrival/exit times, memory access start time or execution start/end times. In some examples, the software entity associated with PASID 522-1 may use this information to make subsequent decisions on whether to continue to use accelerator device 140 for offloading workloads or operations. Process 700 then comes to an end.

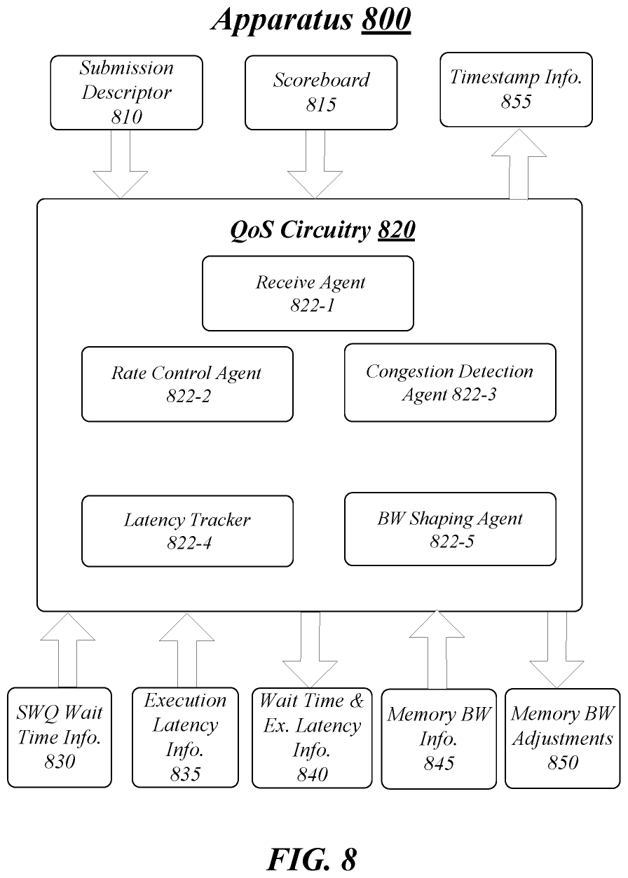

FIG. 8 illustrates an example apparatus 800. Although apparatus 800 shown in FIG. 8 has a limited number of elements in a certain topology, it may be appreciated that the apparatus 800 may include more or less elements in alternate topologies as desired for a given implementation.

According to some examples, apparatus 800 may be supported by QoS circuitry 820 and apparatus 800 may be located at an accelerator device (e.g., accelerator device 140). QoS circuitry 820 may be arranged to execute one or more software or firmware implemented logic, components, agents, or modules 822-a (e.g., implemented, at least in part, by a controller of a memory device). It is worthy to note that “a” and “b” and “c” and similar designators as used herein are intended to be variables representing any positive integer. Thus, for example, if an implementation sets a value for a=5, then a complete set of software or firmware for logic, components, agents, or modules 822-a may include logic 822-1, 822-2, 822-3, 822-4 or 822-5. Also, at least a portion of “logic” may be software/firmware stored in computer-readable media, or may be implemented, at least in part in hardware and although the logic is shown in FIG. 8 as discrete boxes, this does not limit logic to storage in distinct computer-readable media components (e.g., a separate memory, etc.) or implementation by distinct hardware components (e.g., separate processors, processor circuits, ASICs or FPGAs).

According to some examples, QoS circuitry 820 may include at least a portion of one or more ASICs or programmable logic (e.g., FPGA) and, in some examples, at least some logic 822-a may be implemented as hardware elements of these ASICs or programmable logic. For these examples, as shown in FIG. 8, QoS circuitry 820 includes a receive agent 822-1, a rate control agent 822-2, a congestion detection circuitry 822-3, a latency tracker 822-4, and/or a BW shaping agent 822-5 that may be implemented as hardware elements of these ASICs or programmable logic. For example, receive agent circuitry, rate control agent circuitry, congestion detection circuitry, latency tracker circuitry, and/or BW shaping agent circuitry.

In some examples, receive agent 822-1 may be circuitry, a logic and/or a feature of QoS circuitry 820 to receive a submission descriptor for a work request to execute a workload for an application hosted by a compute device coupled with the accelerator device that includes apparatus 800. For these examples, the submission descriptor may be included in submission descriptor 810.

In some examples, rate control agent 822-2 may be circuitry, a logic and/or a feature of QoS circuitry 820 to cause the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor, wherein the work queue is shared with at least one other application hosted by the compute device.

According to some examples, congestion detection agent 822-3 may be circuitry, a logic and/or a feature of QoS circuitry 820 to monitor a wait time at the work queue that starts upon acceptance of the submission descriptor to the work queue. The wait time may be monitored responsive to an indication in the submission descriptor of an expiration time to wait for the submission descriptor to be forwarded from the work queue to the operational unit. For these examples, SWQ wait time information 830 may include monitored information for the SWQ. Congestion detection agent 822-3 may cause the submission descriptor to be removed from the work queue if the monitored wait time meets or exceeds the expiration time.

In some examples, latency tracker 822-4 may be circuitry, a logic and/or a feature of QoS circuitry 820 to monitor a wait time at the work queue for the submission descriptor to be forwarded from the work queue to the operational unit to determine a wait time latency and monitor an execution time for the operational unit to execute the workload to determine an execution latency. For these examples, latency tracker 823-4 may use information included in SWQ wait time information 830 and execution latency information 835 to determine the wait time latency and the execution time latency. Latency tracker 823-4 may cause the wait time latency and the execution latency to be included in a completion record that is to be generated responsive to the operational unit completing execution of the workload. For example, timestamp information 855 may be used to populate timestamp 404 field of a work completion record in the format of example format 400 shown in FIG. 4 to indicate the wait time and execution latencies.

According to some examples, bandwidth shaping agent 822-5 may be circuitry, a logic and/or a feature of QoS circuitry 820 to determine a memory bandwidth consumed by the operational unit in order to execute the workload, the determination made responsive to the operational unit completing execution of the workload. For these examples, bandwidth shaping agent 822-5 may use information included in memory BW information 845 to make the determination. Bandwidth shaping agent 822-5 may then cause an adjustment to memory bandwidth available to the operational unit for executing subsequent workloads based on the determined memory bandwidth consumed. Memory BW adjustments 850 may include those adjustments to memory bandwidth.

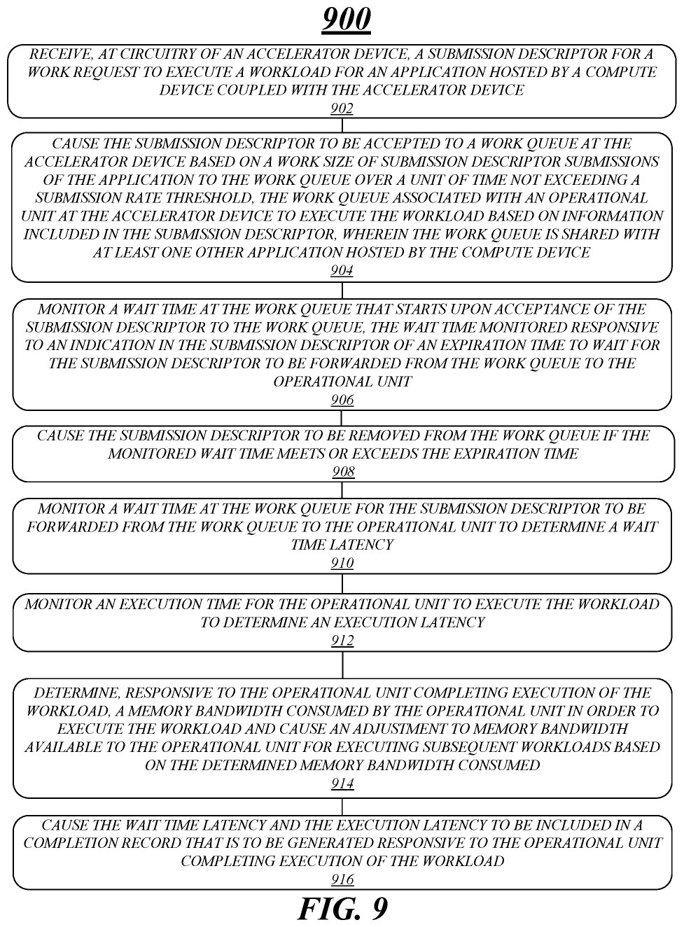

FIG. 9 illustrates an example of a logic flow 900. Logic flow 900 may be representative of some or all of the operations executed by one or more logic, features, or devices described herein, such as circuitry, logic and/or features included in apparatus 800. More particularly, logic flow 900 may be implemented by one or more of receive agent 822-1, rate control agent 822-2, congestion detection agent 822-3, latency tracker 822-4 or bandwidth shaping agent 822-5.

According to some examples, as shown in FIG. 9, logic flow 900 at block 902 may receive, at circuitry of an accelerator device, a submission descriptor for a work request to execute a workload for an application hosted by a compute device coupled with the accelerator device. Then logic flow 900 at block 904 may cause the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor, wherein the work queue is shared with at least one other application hosted by the compute device. For these examples, receive agent 822-1 may receive the submission descriptor and rate control agent 822-2 may cause the submission descriptor to be accepted to the work queue.

In some examples, logic flow 900 at block 906 may monitor a wait time at the work queue that starts upon acceptance of the submission descriptor to the work queue, the wait time monitored responsive to an indication in the submission descriptor of an expiration time to wait for the submission descriptor to be forwarded from the work queue to the operational unit. Then logic flow at 908 may cause the submission descriptor to be removed from the work queue if the monitored wait time meets or exceeds the expiration time. For these examples, congestion detection agent 822-3 may monitor the work queue and cause the submission descriptor to be removed based on the wait time.

According to some examples, logic flow 900 at block 910 may monitor a wait time at the work queue for the submission descriptor to be forwarded from the work queue to the operational unit to determine a wait time latency. Then logic flow at 912 may monitor an execution time for the operational unit to execute the workload to determine an execution latency. For these examples, latency tracker 822-4 may monitor the wait and execution times.

In some examples, logic flow 900 at block 914 may determine, responsive to the operational unit completing execution of the workload, a memory bandwidth consumed by the operational unit in order to execute the workload and adjust memory bandwidth available to the operational unit for executing subsequent workloads based on the determined memory bandwidth consumed. For these examples, bandwidth shaping agent 822-5 may determine the memory bandwidth consumed and cause the adjustment to the memory bandwidth based on this determination.

In some examples, logic flow 900 at block 916 may cause the wait time latency and the execution latency to be included in a completion record that is to be generated responsive to the operational unit completing execution of the workload. For these examples, latency tracker 822-4 may monitor the wait and execution latencies and cause these latencies to be included in the completion record.

The set of logic flows shown in FIGS. 6 and 9 may be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

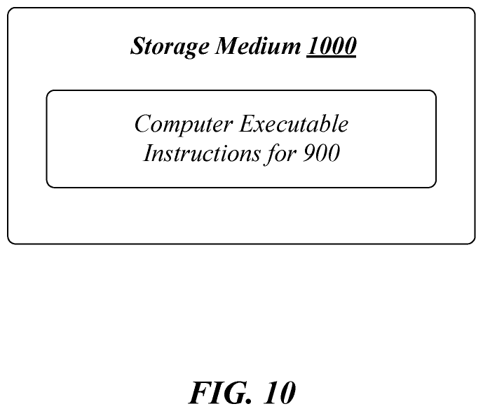

FIG. 10 illustrates an example of a first storage medium. As shown in FIG. 10, the first storage medium includes a storage medium 1000. The storage medium 1000 may comprise an article of manufacture. In some examples, storage medium 1000 may include any non-transitory computer readable medium or machine readable medium, such as an optical, magnetic or semiconductor storage. Storage medium 1000 may store various types of computer executable instructions, such as instructions to implement logic flow 900. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

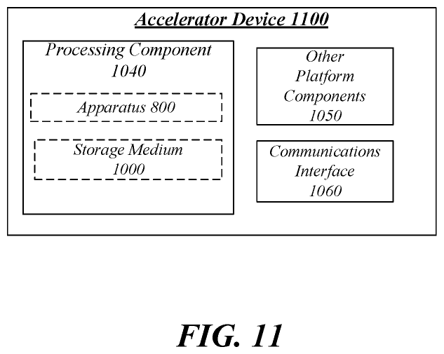

FIG. 11 illustrates an example accelerator device 1100. In some examples, as shown in FIG. 11, accelerator device 1100 may include a processing component 1140, other platform components 1150 or a communications interface 1160. According to some examples, accelerator device 1100 may be coupled to a computing device (e.g., via an I/O fabric).

According to some examples, memory system 1130 may include a controller 1132 and a memory 1134. For these examples, circuitry resident at or located at controller 1132 may be included in a near data processor and may execute at least some processing operations or logic for apparatus 800 based on instructions included in a storage media that includes storage medium 1000. Also, memory 1134 may include similar types of memory that are described above for system 100 shown in FIG. 1. For example, types of memory included in memory 130-1 to 130-N shown in FIG. 1.

According to some examples, processing components 1040 may execute at least some processing operations or logic for apparatus 800 based on instructions included in a storage media that includes storage medium 1000. Processing components 1140 may include various hardware elements, software elements, or a combination of both. For these examples, Examples of hardware elements may include devices, logic devices, components, processors, microprocessors, management controllers, companion dice, circuits, processor circuits, circuit elements (e.g., transistors, resistors, capacitors, inductors, and so forth), integrated circuits, ASICs, programmable logic devices (PLDs), digital signal processors (DSPs), FPGAs, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (APIs), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

According to some examples, processing component 1140 may include an infrastructure processing unit (IPU) or a data processing unit (DPU) or may be utilized by an IPU or a DPU. An xPU may refer at least to an IPU, DPU, graphic processing unit (GPU), general-purpose GPU (GPGPU). An IPU or DPU may include a network interface with one or more programmable or fixed function processors to perform offload of workloads or operations that could have been performed by a CPU. The IPU or DPU can include one or more memory devices (not shown). In some examples, the IPU or DPU can perform virtual switch operations, manage storage transactions (e.g., compression, cryptography, virtualization), and manage operations performed on other IPUs, DPUs, servers, or devices.

In some examples, other platform components 1150 may include common computing elements, memory units (that include system memory), chipsets, controllers, peripherals, interfaces, oscillators, timing devices, video cards, audio cards, multimedia input/output (I/O) components (e.g., digital displays), power supplies, and so forth. Examples of memory units or memory devices included in other platform components 1150 may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1160 may include logic and/or features to support a communication interface. For these examples, communications interface 1160 may include one or more communication interfaces that operate according to various communication protocols or standards to communicate over direct or network communication links. Direct communications may occur via use of communication protocols or standards described in one or more industry standards (including progenies and variants) such as those associated with the PCIe specification, the NVMe specification or the I3C specification. Network communications may occur via use of communication protocols or standards such those described in one or more Ethernet standards promulgated by the Institute of Electrical and Electronics Engineers (IEEE). For example, one such Ethernet standard promulgated by IEEE may include, but is not limited to, IEEE 802.3-2018, Carrier sense Multiple access with Collision Detection (CSMA/CD) Access Method and Physical Layer Specifications, Published in August 2018 (hereinafter “IEEE 802.3 specification”). Network communication may also occur according to one or more OpenFlow specifications such as the OpenFlow Hardware Abstraction API Specification. Network communications may also occur according to one or more Infiniband Architecture specifications.

Accelerator device 1100 may be coupled to a computing device that may be, for example, user equipment, a computer, a personal computer (PC), a desktop computer, a laptop computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

Functions and/or specific configurations of accelerator device 1100 described herein, may be included, or omitted in various embodiments of accelerator device 1100, as suitably desired.

The components and features of accelerator device 1100 may be implemented using any combination of discrete circuitry, ASICs, logic gates and/or single chip architectures. Further, the features of accelerator device 1100 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

It should be appreciated that the exemplary accelerator device 1100 shown in the block diagram of FIG. 11 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Although not depicted, any system can include and use a power supply such as but not limited to a battery, AC-DC converter at least to receive alternating current and supply direct current, renewable energy source (e.g., solar power or motion based power), or the like.

One or more aspects of at least one example may be implemented by representative instructions stored on at least one machine-readable medium which represents various logic within a processor, processor circuit, ASIC, or FPGA which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the processor, processor circuit, ASIC, or FPGA.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example apparatus may include receive agent circuitry at an accelerator device, the receive agent circuitry may receive a submission descriptor for a work request to execute a workload for an application hosted by a compute device coupled with the accelerator device. The apparatus may also include rate control agent circuitry at the accelerator device, the rate control agent circuitry may cause the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor. For this example, the work queue may be shared with at least one other application hosted by the compute device.

Example 2. The apparatus of example 1, the rate control agent circuitry may also cause the submission descriptor to be accepted to the work queue based on a number of slot queues of the work queue currently occupied due to previously accepted submissions of other submission descriptors to the work queue not exceeding a slot queue threshold.

Example 3. The apparatus of example 1 may also include a latency tracker circuitry at the accelerator device. The latency tracker circuitry may monitor a wait time at the work queue that starts upon acceptance of the submission descriptor to the work queue, the wait time monitored responsive to an indication in the submission descriptor of an expiration time to wait for the submission descriptor to be forwarded from the work queue to the operational unit. The latency tracker circuitry may also cause the submission descriptor to be removed from the work queue if the monitored wait time meets or exceeds the expiration time.

Example 4. The apparatus of example 1 may also include a latency tracker circuitry to monitor a wait time at the work queue for the submission descriptor to be forwarded from the work queue to the operational unit to determine a wait time latency. The latency tracker circuitry may also monitor an execution time for the operational unit to execute the workload to determine an execution latency and cause the wait time latency and the execution latency to be included in a completion record that is to be generated responsive to the operational unit completing execution of the workload.

Example 5. The apparatus of example 1 may also include a bandwidth shaping agent circuitry to determine, responsive to the operational unit completing execution of the workload, a memory bandwidth consumed by the operational unit in order to execute the workload. The bandwidth shaping agent circuitry may also cause an adjustment to memory bandwidth available to the operational unit for executing subsequent workloads based on the determined memory bandwidth consumed.

Example 6. The apparatus of example 5, the bandwidth shaping agent circuitry may adjust the memory bandwidth available to the operational unit based on the operational unit exceeding a memory bandwidth quota for memory bandwidth shared with other operational units at the accelerator device.

Example 7. The apparatus of example 1 may also include the receive agent circuitry to receive a second submission descriptor for a second work request to execute a workload for the application. For this example, the rate control agent circuitry may cause a rejection of the second work request based on receipt of the second submission descriptor causing a work size of submission descriptor submissions of the application to the work queue over the unit of time to exceed the submission rate threshold. The rate control agent circuitry may also cause an indication to be generated and sent to the application to indicate rejection of the second work request.

Example 8. The apparatus of example 1, the submission descriptor for the work request may include a DMWr formatted in accordance with the PCI Express specification.

Example 9. The apparatus of example 8, the application may initiate the work request via use of an ENQCMD instruction or an EMQCMDS instruction, the DMWr to include a PASID assigned to the application.

Example 10. The apparatus of example 1, the workload may be for a data streaming operation to include a move operation, a fill operation, a compare operation, a compress operation, a decompress operation, an encrypt operation, a decrypt operation, or a flush operation.

Example 11. An example method may include receiving, at circuitry of an accelerator device, a submission descriptor for a work request to execute a workload for an application hosted by a compute device coupled with the accelerator device. The method may also include causing the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor. For this example, the work queue may be shared with at least one other application hosted by the compute device.

Example 12. The method of example 11 may also include causing the submission descriptor to be accepted to the work queue based on a number of slot queues of the work queue currently occupied due to previously accepted submissions of other submission descriptors to the work queue not exceeding a slot queue threshold.

Example 13. The method of example 11, may also include monitoring a wait time at the work queue that starts upon acceptance of the submission descriptor to the work queue, the wait time monitored responsive to an indication in the submission descriptor of an expiration time to wait for the submission descriptor to be forwarded from the work queue to the operational unit. The method may also include causing the submission descriptor to be removed from the work queue if the monitored wait time meets or exceeds the expiration time.

Example 14. The method of example 11 may also include monitoring a wait time at the work queue for the submission descriptor to be forwarded from the work queue to the operational unit to determine a wait time latency. The method may also include monitoring an execution time for the operational unit to execute the workload to determine an execution latency. The method may also include causing the wait time latency and the execution latency to be included in a completion record that is to be generated responsive to the operational unit completing execution of the workload.

Example 15. The method of example 11 may also include determining, responsive to the operational unit completing execution of the workload, a memory bandwidth consumed by the operational unit in order to execute the workload. The method may also include adjusting memory bandwidth available to the operational unit for executing subsequent workloads based on the determined memory bandwidth consumed.

Example 16. The method of example 15, adjusting the memory bandwidth available to the operational unit may be based on the operational unit exceeding a memory bandwidth quota for memory bandwidth shared with other operational units at the accelerator device.

Example 17. The method of example 11 may also include receiving a second submission descriptor for a second work request to execute a workload for the application. The method may also include causing a rejection of the second work request based on receipt of the second submission descriptor causing a work size of submission descriptor submissions of the application to the work queue over the unit of time to exceed the submission rate threshold. The method may also include causing an indication to be generated and sent to the application to indicate rejection of the second work request.

Example 18. The method of example 11, the submission descriptor for the work request comprises a DMWr formatted in accordance with the PCI Express specification.

Example 19. The method of example 18, the application may initiate the work request via use of an ENQCMD instruction or an EMQCMDS instruction, the DMWr to include a PASID assigned to the application.

Example 20. The method of example 11, the workload may be for a data streaming operation to include a move operation, a fill operation, a compare operation, a compress operation, a decompress operation, an encrypt operation, a decrypt operation, or a flush operation.

Example 21. An example accelerator device may include a memory, a plurality of operational units and circuitry. The circuitry may receive a submission descriptor for a work request to execute a workload for an application hosted by a compute device coupled with the accelerator device. The circuitry may also cause the submission descriptor to be accepted to a work queue included in the memory based on a work size of submission descriptor submissions of the application to the work queue over a unit of time not exceeding a submission rate threshold, the work queue associated with an operational unit from among the plurality of operational units, the operational unit to execute the workload based on information included in the submission descriptor. For this example, the work queue may be shared with at least one other application hosted by the compute device.

Example 22. The accelerator device of example 21, the circuitry may also cause the submission descriptor to be accepted to the work queue based on a number of slot queues of the work queue currently occupied due to previously accepted submissions of other submission descriptors to the work queue not exceeding a slot queue threshold.

Example 23. The accelerator device of example 21, the circuitry may also monitor a wait time at the work queue that starts upon acceptance of the submission descriptor to the work queue, the wait time monitored responsive to an indication in the submission descriptor of an expiration time to wait for the submission descriptor to be forwarded from the work queue to the operational unit. The circuitry may also cause the submission descriptor to be removed from the work queue if the monitored wait time meets or exceeds the expiration time.

Example 24. The accelerator device of example 21, the circuitry may also monitor a wait time at the work queue for the submission descriptor to be forwarded from the work queue to the operational unit to determine a wait time latency. The circuitry may also monitor an execution time for the operational unit to execute the workload to determine an execution latency. The circuitry may also cause the wait time latency and the execution latency to be included in a completion record that is to be generated responsive to the operational unit completing execution of the workload.

Example 25. The accelerator device of example 21, the circuitry may also, responsive to the operational unit completing execution of the workload, determine a memory bandwidth consumed by the operational unit in order to execute the workload. The circuitry may also adjust memory bandwidth available to the operational unit for executing subsequent workloads based on the determined memory bandwidth consumed.

Example 26. The accelerator device of example 25, the circuitry may also adjust the memory bandwidth available to the operational unit based on the operational unit exceeding a memory bandwidth quota for memory bandwidth shared with other operational units from among the plurality of operational units.

Example 27. The accelerator device of example 21, the circuitry may also receive a second submission descriptor for a second work request to execute a workload for the application. The circuitry may also cause a rejection of the second work request based on receipt of the second submission descriptor causing a work size of submission descriptor submissions of the application to the work queue over the unit of time to exceed the submission rate threshold. The circuitry may also cause an indication to be generated and sent to the application to indicate rejection of the second work request.

Example 28. The accelerator device of example 21, the submission descriptor for the work request may be a DMWr formatted in accordance with the PCI Express specification.

Example 29. The accelerator device of example 28, the application may initiate the work request via use of an ENQCMD instruction or an EMQCMDS instruction, the DMWr to include a PASID assigned to the application.

Example 30. The accelerator device of example 21, the workload may be for a data streaming operation to include a move operation, a fill operation, a compare operation, a compress operation, a decompress operation, an encrypt operation, a decrypt operation, or a flush operation.

Example 31. An example at least one machine readable medium comprising a plurality of instructions that in response to being executed by a system at an accelerator device, may cause the system to receive a submission descriptor for a work request to execute a workload for an application hosted by a compute device coupled with the accelerator device. The instructions may also cause the system to cause the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor. For this example, the work queue may be shared with at least one other application hosted by the compute device.

Example 32. The at least one machine readable medium of example 31, the instructions may further cause the system to cause the submission descriptor to be accepted to the work queue based on a number of slot queues of the work queue currently occupied due to previously accepted submissions of other submission descriptors to the work queue not exceeding a slot queue threshold.

Example 33. The at least one machine readable medium of example 31, the instructions may further cause the system to monitor a wait time at the work queue that starts upon acceptance of the submission descriptor to the work queue, the wait time monitored responsive to an indication in the submission descriptor of an expiration time to wait for the submission descriptor to be forwarded from the work queue to the operational unit. The instructions may also cause the system to cause the submission descriptor to be removed from the work queue if the monitored wait time meets or exceeds the expiration time.

Example 34. The at least one machine readable medium of example 31, the instructions may further cause the system to monitor a wait time at the work queue for the submission descriptor to be forwarded from the work queue to the operational unit to determine a wait time latency. The instructions may also cause the system to monitor an execution time for the operational unit to execute the workload to determine an execution latency. The instructions may also cause the system to cause the wait time latency and the execution latency to be included in a completion record that is to be generated responsive to the operational unit completing execution of the workload.

Example 35. The at least one machine readable medium of example 31, the instructions may further cause the system to determine, responsive to the operational unit completing execution of the workload, a memory bandwidth consumed by the operational unit in order to execute the workload. The instructions may also cause the system to adjust memory bandwidth available to the operational unit for executing subsequent workloads based on the determined memory bandwidth consumed.

Example 36. The at least one machine readable medium of example 35, the instructions may cause the system to adjust the memory bandwidth available to the operational unit based on the operational unit exceeding a memory bandwidth quota for memory bandwidth shared with other operational units at the accelerator device.

Example 37. The at least one machine readable medium of example 31, the instructions may further cause the system to receive a second submission descriptor for a second work request to execute a workload for the application. The instructions may also cause the system to cause a rejection of the second work request based on receipt of the second submission descriptor causing a work size of submission descriptor submissions of the application to the work queue over the unit of time to exceed the submission rate threshold. The instructions may also cause the system to cause an indication to be generated and sent to the application to indicate rejection of the second work request.

Example 38. The at least one machine readable medium of example 31, the submission descriptor for the work request may be a DMWr formatted in accordance with the PCI Express specification.

Example 39. The at least one machine readable medium of example 38, the application may initiate the work request via use of an ENQCMD instruction or an EMQCMDS instruction, the DMWr to include a PASID assigned to the application.

Example 40. The at least one machine readable medium of example 31, the workload may be for a data streaming operation to include a move operation, a fill operation, a compare operation, a compress operation, a decompress operation, an encrypt operation, a decrypt operation, or a flush operation.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
receive agent circuitry at an accelerator device, the receive agent circuitry to receive a submission descriptor for a work request to execute a workload for an application hosted by a compute device coupled with the accelerator device; and
rate control agent circuitry at the accelerator device, the rate control agent circuitry to cause the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor, wherein the work queue is shared with at least one other application hosted by the compute device.

2. The apparatus of claim 1, further comprising the rate control agent circuitry to:
cause the submission descriptor to be accepted to the work queue based on a number of slot queues of the work queue currently occupied due to previously accepted submissions of other submission descriptors to the work queue not exceeding a slot queue threshold.

3. The apparatus of claim 1, further comprising:
a latency tracker circuitry at the accelerator device to:
monitor a wait time at the work queue that starts upon acceptance of the submission descriptor to the work queue, the wait time monitored responsive to an indication in the submission descriptor of an expiration time to wait for the submission descriptor to be forwarded from the work queue to the operational unit; and
cause the submission descriptor to be removed from the work queue if the monitored wait time meets or exceeds the expiration time.

4. The apparatus of claim 1, further comprising:
a latency tracker circuitry to:
monitor a wait time at the work queue for the submission descriptor to be forwarded from the work queue to the operational unit to determine a wait time latency;
monitor an execution time for the operational unit to execute the workload to determine an execution latency; and
cause the wait time latency and the execution latency to be included in a completion record that is to be generated responsive to the operational unit completing execution of the workload.

5. The apparatus of claim 1, further comprising:
a bandwidth shaping agent circuitry to:
determine, responsive to the operational unit completing execution of the workload, a memory bandwidth consumed by the operational unit in order to execute the workload; and
cause an adjustment to memory bandwidth available to the operational unit for executing subsequent workloads based on the determined memory bandwidth consumed.

6. The apparatus of claim 5, comprising the bandwidth shaping agent circuitry to adjust the memory bandwidth available to the operational unit based on the operational unit exceeding a memory bandwidth quota for memory bandwidth shared with other operational units at the accelerator device.

7. The apparatus of claim 1, further comprising:
the receive agent circuitry to receive a second submission descriptor for a second work request to execute a workload for the application; and
the rate control agent circuitry to:
cause a rejection of the second work request based on receipt of the second submission descriptor causing a work size of submission descriptor submissions of the application to the work queue over the unit of time to exceed the submission rate threshold; and
cause an indication to be generated and sent to the application to indicate rejection of the second work request.

8. The apparatus of claim 1, the submission descriptor for the work request comprises a Deferrable Memory Write request (DMWr) formatted in accordance with the PCI Express specification.

9. The apparatus of claim 8, comprising the application to initiate the work request via use of an Enqueue Command (ENQCMD) instruction or an Enqueue Command as Supervisor (EMQCMDS) instruction, the DMWr to include a Process Address Space Identifier (PASID) assigned to the application.

10. The apparatus of claim 1, comprising the workload is for a data streaming operation to include a move operation, a fill operation, a compare operation, a compress operation, a decompress operation, an encrypt operation, a decrypt operation, or a flush operation.

11. A method comprising:
receiving, at circuitry of an accelerator device, a submission descriptor for a work request to execute a workload for an application hosted by a compute device coupled with the accelerator device; and
causing the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor, wherein the work queue is shared with at least one other application hosted by the compute device.

12. The method of claim 11, further comprising:
causing the submission descriptor to be accepted to the work queue based on a number of slot queues of the work queue currently occupied due to previously accepted submissions of other submission descriptors to the work queue not exceeding a slot queue threshold.

13. The method of claim 11, further comprising:
receiving a second submission descriptor for a second work request to execute a workload for the application;
causing a rejection of the second work request based on receipt of the second submission descriptor causing a work size of submission descriptor submissions of the application to the work queue over the unit of time to exceed the submission rate threshold;
causing an indication to be generated and sent to the application to indicate rejection of the second work request.

14. The method of claim 11, comprising the workload is for a data streaming operation to include a move operation, a fill operation, a compare operation, a compress operation, a decompress operation, an encrypt operation, a decrypt operation, or a flush operation.

15. An accelerator device comprising:
a memory;
a plurality of operational units; and
circuitry to:
receive a submission descriptor for a work request to execute a workload for an application hosted by a compute device coupled with the accelerator device; and
cause the submission descriptor to be accepted to a work queue included in the memory based on a work size of submission descriptor submissions of the application to the work queue over a unit of time not exceeding a submission rate threshold, the work queue associated with an operational unit from among the plurality of operational units, the operational unit to execute the workload based on information included in the submission descriptor, wherein the work queue is shared with at least one other application hosted by the compute device.

16. The accelerator device of claim 15, further comprising the circuitry to:
cause the submission descriptor to be accepted to the work queue based on a number of slot queues of the work queue currently occupied due to previously accepted submissions of other submission descriptors to the work queue not exceeding a slot queue threshold.

17. The accelerator device of claim 15, comprising the circuitry to:
receive a second submission descriptor for a second work request to execute a workload for the application;
cause a rejection of the second work request based on receipt of the second submission descriptor causing a work size of submission descriptor submissions of the application to the work queue over the unit of time to exceed the submission rate threshold;
cause an indication to be generated and sent to the application to indicate rejection of the second work request.

18. The accelerator device of claim 15, comprising the workload is for a data streaming operation to include a move operation, a fill operation, a compare operation, a compress operation, a decompress operation, an encrypt operation, a decrypt operation, or a flush operation.

19. At least one machine readable medium comprising a plurality of instructions that in response to being executed by a system at an accelerator device, cause the system to:
receive a submission descriptor for a work request to execute a workload for an application hosted by a compute device coupled with the accelerator device; and
cause the submission descriptor to be accepted to a work queue at the accelerator device based on a work size of submission descriptor submissions of the application to the work queue over a unit of time not exceeding a submission rate threshold, the work queue associated with an operational unit at the accelerator device to execute the workload based on information included in the submission descriptor, wherein the work queue is shared with at least one other application hosted by the compute device.

20. The at least one machine readable medium of claim 18, comprising the instructions to further cause the system to:
cause the submission descriptor to be accepted to the work queue based on a number of slot queues of the work queue currently occupied due to previously accepted submissions of other submission descriptors to the work queue not exceeding a slot queue threshold.

21. The at least one machine readable medium of claim 19, comprising the instructions to further cause the system to:
monitor a wait time at the work queue that starts upon acceptance of the submission descriptor to the work queue, the wait time monitored responsive to an indication in the submission descriptor of an expiration time to wait for the submission descriptor to be forwarded from the work queue to the operational unit; and
cause the submission descriptor to be removed from the work queue if the monitored wait time meets or exceeds the expiration time.

22. The at least one machine readable medium of claim 19, comprising the instructions to further cause the system to:
monitor a wait time at the work queue for the submission descriptor to be forwarded from the work queue to the operational unit to determine a wait time latency;
monitor an execution time for the operational unit to execute the workload to determine an execution latency; and
cause the wait time latency and the execution latency to be included in a completion record that is to be generated responsive to the operational unit completing execution of the workload.

23. The at least one machine readable medium of claim 19, comprising the instructions to further cause the system to:
determine, responsive to the operational unit completing execution of the workload, a memory bandwidth consumed by the operational unit in order to execute the workload; and
adjust memory bandwidth available to the operational unit for executing subsequent workloads based on the determined memory bandwidth consumed.

24. The at least one machine readable medium of claim 23, comprising the instructions to cause the system to adjust the memory bandwidth available to the operational unit based on the operational unit exceeding a memory bandwidth quota for memory bandwidth shared with other operational units at the accelerator device.

25. The at least one machine readable medium of claim 19, comprising the instructions to further cause the system to:
receive a second submission descriptor for a second work request to execute a workload for the application;
cause a rejection of the second work request based on receipt of the second submission descriptor causing a work size of submission descriptor submissions of the application to the work queue over the unit of time to exceed the submission rate threshold;
cause an indication to be generated and sent to the application to indicate rejection of the second work request.

26. The at least one machine readable medium of claim 19, the submission descriptor for the work request comprises a Deferrable Memory Write request (DMWr) formatted in accordance with the PCI Express specification, wherein the application is to initiate the work request via use of an Enqueue Command (ENQCMD) instruction or an Enqueue Command as Supervisor (EMQCMDS) instruction, the DMWr to include a Process Address Space Identifier (PASID) assigned to the application.

27. The at least one machine readable medium of claim 19, comprising the workload is for a data streaming operation to include a move operation, a fill operation, a compare operation, a compress operation, a decompress operation, an encrypt operation, a decrypt operation, or a flush operation.
